(19) United States
(12) Patent Application Publication
(10) Pub. No.: US 2007/0245377 A1
(43) Pub. Date: Oct. 18, 2007

(54) Central system providing previews to a portable media player

(75) Inventor: Hugh Svendsen, Chapel Hill, NC (US)

Correspondence Address: CONCERT TECHNOLOGY AND WITHROW & TERRANOVA, 100 REGENCY FOREST DRIVE , SUITE 160, CARY, NC, 27518, US

(73) Assignee: CONCERT TECHNOLOGY CORPORATION, Durham, NC (US)

(21) Appl. No.: 11/403,597

(22) Filed: Apr. 13, 2006

(51) Int. Cl. H04N 5/445

(52) U.S. Cl. 725/46

(57) ABSTRACT

A system and method for providing previews, such as song and video previews, to a portable media player are provided. In general, a play history for the portable media player is generated as media files are played by the portable media player and provided to a central system hosting an e-commerce service providing media content. The play history is provided to a central system either indirectly through an associated user system or directly through a network. Based on the play history, the central system selects a number of previews for the portable media player. The previews are provided to the portable media player either indirectly through the associated user system or directly through the network. The previews may then be played on the portable media player and, if desired, selected for purchase.

### FIELD OF THE INVENTION

The present invention relates to a system for providing previews, such as song or video previews, to a portable media player.

### BACKGROUND OF THE INVENTION

Numerous online media stores, such as Apple's iTunes, are currently available for purchasing media content for portable media players, such as Apple iPods, Moving Pictures Experts Group (MPEG) Layer 3 (MP3) players, or the like. However, in order to purchase media content, such as songs or videos, a user must dedicate valuable time to interact with the online media store. More specifically, in order to identify new media content that the user may want to purchase, the user must sit at his or her personal computer and select previews for playback. Once desired media content is identified, the media content is purchased and may thereafter be transferred to the user's portable media player.

The issue with these online media stores is that, in today's busy world, it is not desirable for a user to be required to dedicate valuable time interacting with online media stores simply to preview media content that he or she may want to purchase. Thus, there is a need for a system and method for automatically providing previews of media content to a user's portable media player.

### SUMMARY OF THE INVENTION

The present invention provides a system and method for providing previews, such as song and video previews, to a portable media player. In general, a play history for the portable media player is generated as media files are played by the portable media player and provided to a central system hosting an e-commerce service, which provides media content. The play history is provided to the central system either indirectly through an associated user system or directly through a network. Based on the play history, the central system selects a number of previews for the portable media player. The previews are provided to the portable media player either indirectly through the associated user system or directly through the network. The previews may then be played on the portable media player and, if desired, selected for purchase.

In one embodiment, the play history of the portable media player is first provided to the user system associated with the portable media player during a synchronization process during which the portable media player is docked to the user system. The play history is then provided from the user system to the central system. Based on the play history, the central system selects previews and provides the selected previews to the user system associated with the portable media player. The previews are then provided to the portable media player during the same or a subsequent synchronization process. The previews may then be played on the portable media player and, if desired, selected for purchase. Information identifying the selected previews is provided to the user system during a subsequent synchronization process. In response, media files corresponding to the selected previews are purchased and provided to the portable media player.

In another embodiment, the portable media player includes a wireless interface to the network, which is preferably the Internet, and the play history is provided directly from the portable media player to the central system via the network. Based on the play history, the central system selects previews and returns the previews to the portable media player. The previews may then be played on the portable media player and, if desired, selected for purchase. If previews are selected for purchase, the portable media player communicates with the central system to purchase the media files corresponding to the selected previews.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 illustrates a system for providing previews to a portable media player according to one embodiment of the present invention;

FIGS. 2A-2D illustrate exemplary embodiments of the operation of the system of FIG. 1 according to the present invention;

FIGS. 3A-3D illustrate an exemplary graphical user interface of the portable media player of FIG. 1 according to one embodiment of the present invention;

FIGS. 4A-4D further illustrate an exemplary graphical user interface of the portable media player of FIG. 1 according to one embodiment of the present invention;

FIG. 5 illustrates a system for providing previews to a portable media player according to another embodiment of the present invention;

FIG. 6 illustrates the operation of the system of FIG. 5 according to one embodiment of the present invention;

FIG. 7 is a block diagram of an exemplary embodiment of the portable media player of FIG. 1 according to one embodiment of the present invention;

FIG. 8 is a block diagram of an exemplary embodiment of the user system of FIG. 1 according to one embodiment of the present invention;

FIG. 9 is a block diagram of an exemplary embodiment of the server of FIGS. 1 and 5 according to one embodiment of the present invention; and

FIG. 10 is a block diagram of an exemplary embodiment of the portable media player of FIG. 5 according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

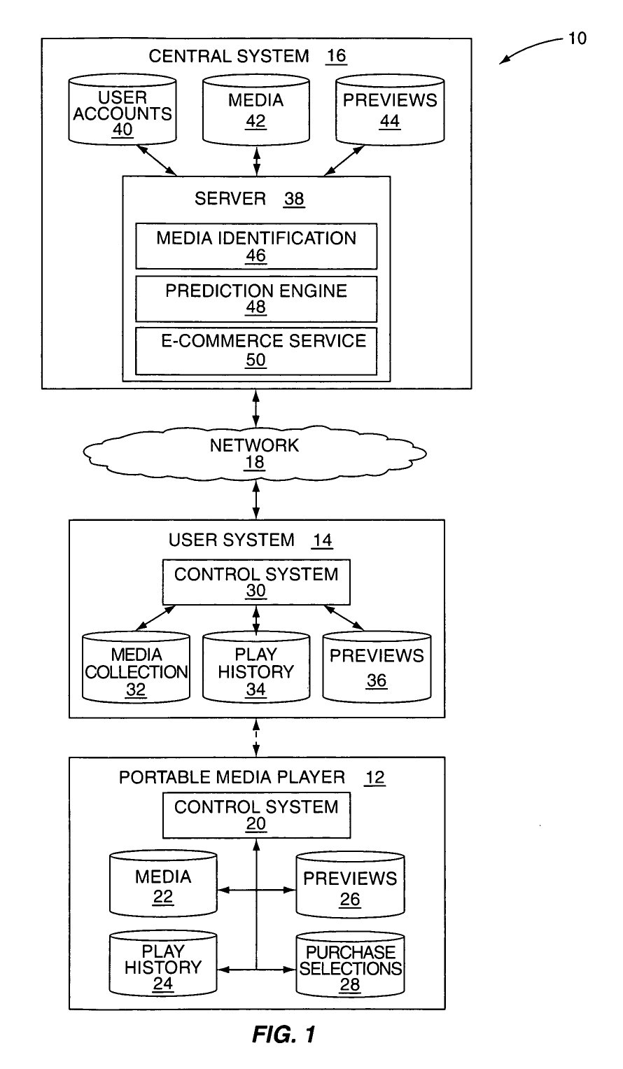

FIG. 1 illustrates a system 10 operating to provide previews to a portable media player 12 according to one embodiment of the present invention. In general, the system 10 includes the portable media player 12, a user system 14, and a central system 16. The user system 14 and the central system 16 are communicatively coupled by a network 18, which is preferably the Internet. The portable media player 12 may be a device similar to an Apple iPod and may be enabled to play audio content such as songs, video content such as movies or television programs, or both audio and video content. The portable media player 12 generally includes a control system 20 and a number of databases 22-28. While the databases 22-28 are illustrated separately for clarity, it is to be understood that they may be implemented in one or more storage units such as, but not limited to, a hard-disc drive, Random-Access Memory (RAM), or the like.

The databases 22-28 include a media database 22, a play history database 24, a previews database 26, and a purchase selections database 28. The media database 22 operates to store a number of media files, such as song files and video files, which may be selected and played by the portable media player 12. Generally, the media files include media content encoded with an encoding algorithm. The media content is the song, movie, television program, or the like.

The play history database 24 operates to store a play history of the portable media player 12. For each media file played by the portable media player 12, the play history includes an identifier, such as a Globally Unique Identifier (GUID), and a time stamp identifying a time and date at which the media file was played. The GUID of a media file identifies the media content of the media file. For example, the GUID of a song file identifies the song. If the song is owned by multiple users, the song files owned by each of the users have the same GUID. Note that if a media file is played multiple times, the play history may include a separate entry for each playing of the media file or multiple time stamps stored in association with the identifier of the media file.

The previews database 26 operates to store a number of previews of media content, such as previews of songs or videos. A preview is preferably a media file corresponding to a segment of the media content, such as a thirty second segment of a song or a five minute segment of a movie or television program. A preview may alternatively be the entire media file with Digital Rights Management (DRM) restrictions permitting only a segment of the media content to be played or permitting the entire media content to be played only a limited number of times, such as three. As discussed below, the previews are selected by the central system 16 based on the current play history or a previous version of the play history of the portable media player 12. In this embodiment, once selected, the previews are provided to the portable media player 12 via the user system 14.

The purchase selections database 28 stores identifiers of the previews selected by the user for purchase by the user. The identifiers of the previews may be the GUIDs of the associated media content.

The user system 14 may be a personal computer or the like associated with the portable media player 12. In general, the user system 14 includes a control system 30, a media collection database 32, a play history database 34, and a previews database 36. While the databases 32-36 are illustrated separately for clarity, they may be implemented in one or more storage units such as, but not limited to, one or more hard-disc drives. The media collection database 32 operates to store a number of media files, such as song files and video files, corresponding to a media collection of the user associated with the user system 14 and the portable media player 12. The play history database 34 operates to store a play history including an identifier, such as a GUID, and a time stamp for each media file played at the user system 14. In addition, the play history database 34 operates to store the play history from the portable media player 12, which may be provided to the user system 14 during a synchronization process during which the portable media player 12 is docked, or communicatively coupled, to the user system 14.

The previews database 36 operates to store previews obtained from the central system 16 based on the play history for the portable media player 12 and optionally the play history of the user system 14 and a user profile of the user associated with the portable media player 12 and the user system 14. The previews may be viewed or listened to at the user system 14. However, the previews are preferably provided to the portable media player 12 during a synchronization process, wherein the portable media player 12 is docked, or communicatively coupled, to the user system 14 via a local wireless interface such as a Bluetooth or Zigbee interface or a wired interface such as a Universal Serial Bus (USB) or Firewire interface. The synchronization process may be performed when desired by the user to, for example, transfer media files to the portable media player 12 and charge a battery of the portable media player 12. According to the present invention, while the portable media player 12 is docked to the user system 14 for a synchronization process, previews are provided the portable media player 12. The previews provided to the portable media player 12 are selected by the central system 16 based on the current play history of the portable media player 12 or a previous play history of the portable media player 12 provided to the user system 14 during a previous synchronization process. The user may thereafter view or listen to the previews and, if desired, select one or more previews in order to purchase corresponding media files from the central system 16 when subsequently docked to the user system 14.

The central system 16 is effectively a networked media store enabling purchase and download of media files corresponding to media content such as songs, movies, television programs, and the like. The central system 16 includes a server 38 and databases 40-44. The server 38 is preferably implemented as a combination of hardware and software and includes a media identification application 46, a prediction engine 48, and an e-commerce service 50. Note that while a single server 38 is illustrated, the server 38 may be implemented as a number of distributed servers.

The media identification application 46 operates to identify the media content of the media files in the media collection 32 stored at the user system 14 and assign corresponding identifiers, or GUIDs, to the media files. More specifically, media files purchased from the central system 16 preferably have associated GUIDs identifying the media content of the media files. For example, the song “Ring of Fire” by Johnny Cash preferably has a particular GUID. However, media files not purchased from the central system 16, such as songs “ripped” from a Compact Disc (CD) or media files otherwise encoded by the user, are not initially associated with, or tagged with, GUIDs. In order to obtain the GUIDs for the media files, identification parameters such as, but not limited to, metadata, such as ID3 tags, describing the media content of the media files; fingerprints of the media content of the media files; samples of the media content of the media files; file names; directory names; or the like or any combination thereof may be provided to the central system 16. In response, the media identification application 46 attempts to identify the media content of the media files based on the identification parameters. For media files having media content identified by the media identification application 46, the corresponding GUIDs are provided to the user system 14 and stored in association with the media files. For example, the GUIDs may be stored in the headers of the media files. Thereafter, the media files may be identified using the GUIDs. In addition, the GUIDs for the media files in the media collection 32 may be stored at the central system 16 as information identifying the media files in the user's music collection 32. In one embodiment, the GUIDs are stored as part of a user profile of the user associated with the portable media player 12 and the user system 14.

The details of identifying the media content of media files based on the identification parameters is not central to the present invention. Numerous methods for identifying the media content of media files based on the identification parameters will be apparent to one of ordinary skill in the art upon reading this disclosure. As an example, see U.S. Pat. No. 6,990,453, entitled SYSTEM AND METHODS FOR RECOGNIZING SOUND AND MUSIC SIGNALS IN HIGH NOISE AND DISTORTION, issued Jan. 24, 2006, which is hereby incorporated by reference in its entirety.

The prediction engine 48 may be implemented in software, hardware, or a combination of hardware and software. In general, the prediction engine 48 operates to select one or more previews from a previews database 44 to be provided to the portable media player 12 based on the play history of the portable media player 12. Optionally, the previews may additionally be selected based on the play history of the user system 14 and the user profile of the user associated with the portable media player 12 and the user system 14. The user profile may include the information identifying the media files in the music collection 32, demographic information, user preferences, and the like.

The e-commerce service 50 may be implemented in software or a combination of hardware and software and operates to enable users, such as the user of the user system 14, to purchase and download media files corresponding to media content such as songs, movies, television programs, and the like.

The databases 40-44 include a user accounts database 40, a media database 42, and the previews database 44. The user accounts database 40 may include a user profile for each user registered with the central system 16. A user may be registered with the central system 16 to purchase media content and receive previews according to the present invention. The user profile may include information such as, but not limited to, a name, home address, email address, telephone number, demographic information, user preferences, and purchase history for the associated user. In addition, as discussed above, the user profile may include information identifying the user's media collection, such as the GUID for each known media file in the user's media collection. A media file is known if the central system 16 can identify the media content of the media file.

The media database 42 operates to store a number of media files corresponding to media content that may be purchased from the central system 16. The media files may include media content such as songs, movies, television programs, or the like. Each of the media files preferably includes a GUID identifying the media content of the media file. For example, if a media file is a song file, the media content is the song, and the GUID identifies the song. The previews database 44 includes previews of the media content of all or a portion of the media files stored in the media database 42. The previews may, for example, be generated by the central system 16 when corresponding media files are added to the media database 42. Alternatively, the previews may be dynamically generated after the prediction engine 48 selects previews to provide to the portable media player 12. The previews may be media files corresponding to segments of the media content of the media files or a full version of the media files having DRM restrictions enabling only a segment of the media content to be played or enabling the entire media content to be played only a limited number of times.

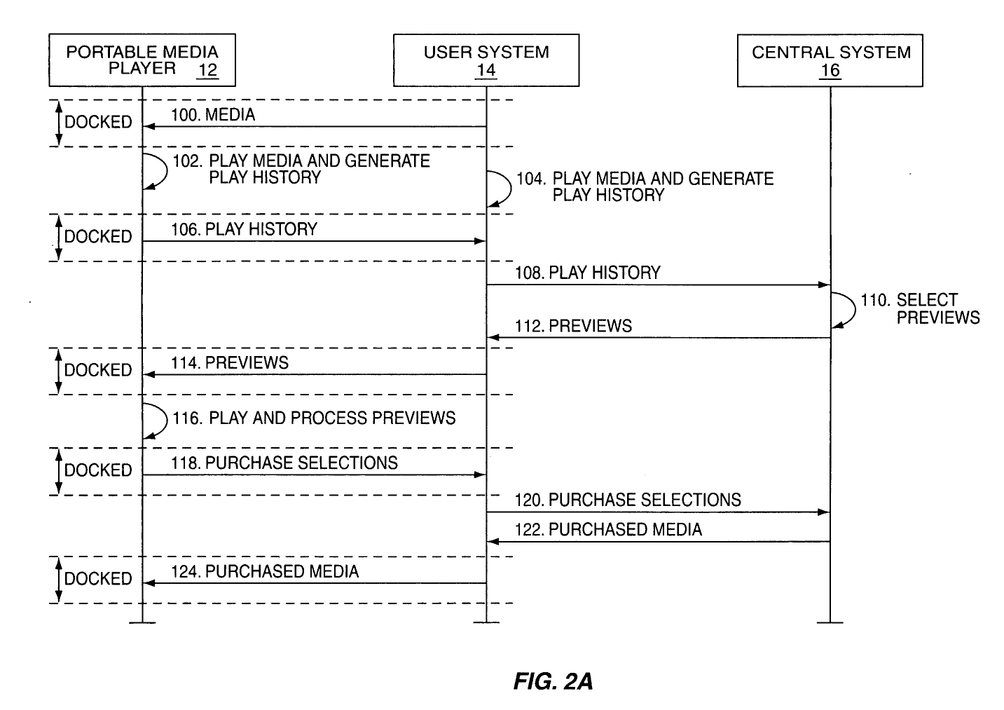

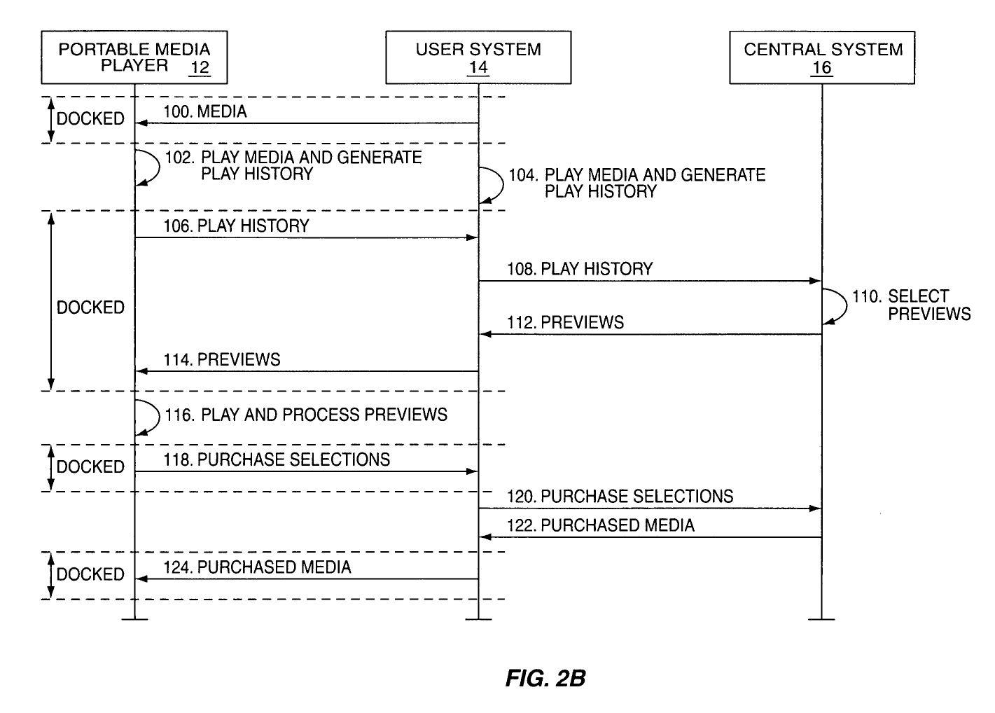

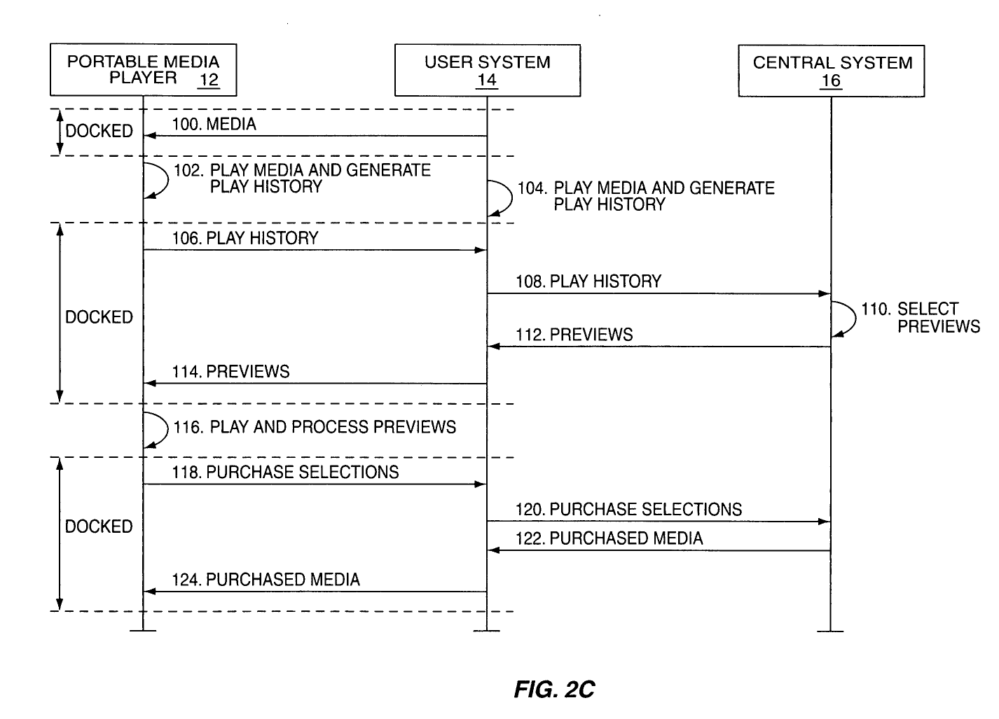

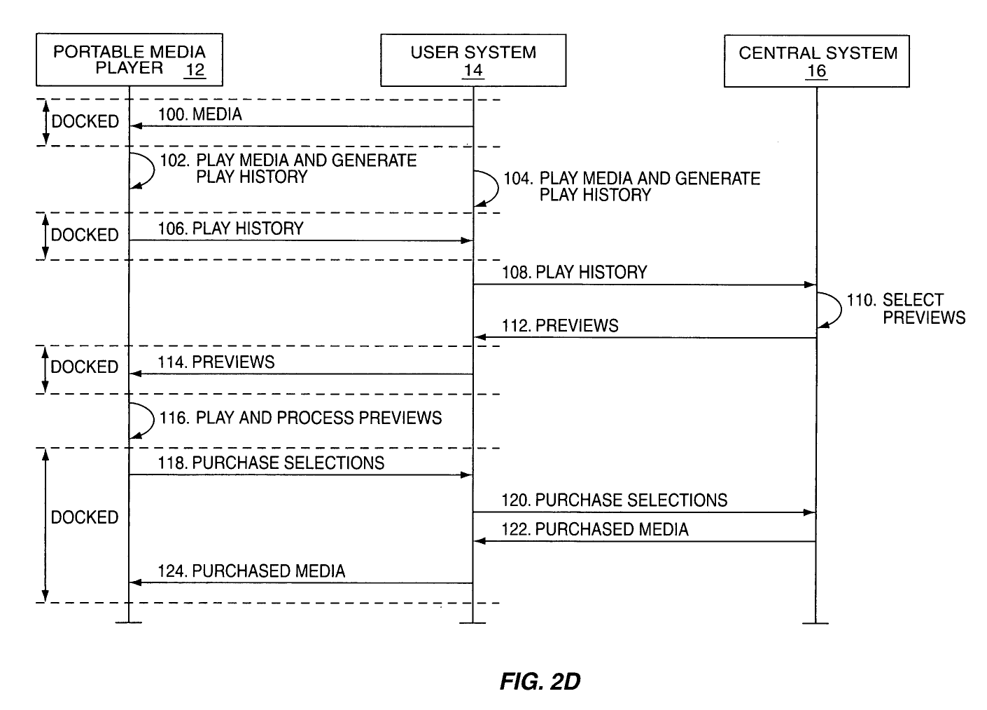

FIG. 2A illustrates the operation of the system 10 of FIG. 1 according to a first embodiment of the present invention. In general, the process begins when media files are transferred to the portable media player 12 from the user system 14 during a synchronization process (step 100). The media files are from the media collection 32 stored on the user system 14. As discussed above, the media files in the media collection 32 corresponding to media content that is known to the central system 16 preferably include, or are tagged with, GUIDs provided by the central system 16 identifying the media content of the media files. The portable media player 12 is then undocked from the user system 14. While the portable media player 12 is undocked, the user plays desired ones of the media files, and a play history is generated (step 102). For each media file played, the play history preferably includes the GUID identifying the media content of the media file and a time stamp identifying a time and date at which the media file was played. In addition, a play history may also be generated for the user system 14 to identify media files played at the user system 14 (step 104).

At some point, the portable media player 12 is again docked to the user system 14. While docked, the play history for the portable media player 12 is provided to the user system 14 (step 106). The play history for the portable media player 12 and, optionally, the play history for the user system 14 are provided to the central system 16 (step 108). As illustrated, the portable media player 12 is undocked from the user system 14 before the play history is provided to the central system 16. However, the present invention is not limited thereto. The user system 14 may begin the process of sending the play history to the central system 16 before the portable media player 12 is undocked from the user system 14.

Based on the play history of the portable media player 12 and, optionally, the play history of the user system 14 and the user profile of the user associated with the portable media player 12 and the user system 14, the central system 16, and specifically the prediction engine 48, operates to select previews for the portable media player 12 (step 110). For example, if the play history of the portable media player 12 indicates that the user has recently listened to numerous songs from the 80's music genre, the central system 16 may select previews of other songs from the 80's genre. If the play history of the portable media player 12 and the play history of the user system 14 indicate that the user has recently viewed episodes of a particular television program, the central system 16 may select previews of other episodes of the television program or episodes of similar television programs. In addition, if the information identifying the media files in the media collection 32 indicates that the media collection 32 includes numerous songs from the Classic Rock music genre, the central system 16 may additionally select previews of songs from the Classic Rock music genre that are not already in the media collection 32. These examples are not intended to limit the scope of the present invention. Numerous variations in how the play history of the portable media player 12, the play history of the user system 14, and the user profile of the user associated with the portable media player 12 and the user system 14 may be used to select previews will be apparent to one of ordinary skill in the art upon reading this disclosure.

The number of previews selected by the prediction engine 48 may be a default number such as ten, fifty, or a hundred. Alternatively, the number of previews selected by the prediction engine 48 may be defined by the user and stored, for example, in the user profile of the user. As another alternative, the number of previews to be selected by the prediction engine 48 may be provided to the central system 16 along with the play history, wherein the number is determined by the portable media player 12 or the user system 14 based on an amount of free storage space on the portable media player 12.

Note that the previews may be stored in the previews database 44. Alternatively, the selected previews may be dynamically generated from the corresponding media file stored in the media database 42. Once dynamically generated, the previews may be permanently stored in the previews database 44 such that the previews do not need to be regenerated each time they are to be provided to a portable media player, such as the portable media player 12. Alternatively, the most recent or most popular previews may be cached in the previews database 44.

The selected previews are then provided to the user system 14 (step 112). In this example, when the previews are provided to the user system 14, the portable media player 12 is not docked to the user system 14. As such, the previews are stored in the previews database 36 of the user system 14 until the portable media player 12 is docked to the user system 14. Note that the previews may be played at the user system 14.

Once the portable media player 12 is docked to the user system 14, the previews are provided to the portable media player 12 (step 114). Thereafter, the portable media player 12 may be undocked. While undocked, the previews may be played and processed on the portable media player 12 (step 116). More specifically, the previews may be played by the portable media player 12. Upon viewing or listening to each of the previews, the user may select the preview for purchase, mark the preview for removal or deletion, mark the preview as “hold” such that the preview may be played again at a later time, or mark the preview as “watch for promotion” such that the user may be given the option to purchase the associated media content when a promotion is being run for the associated media content.

When the portable media player 12 is again docked to the user system 14, the purchase selections are provided to the user system 14 (step 118). Preferably, the purchase selections are the GUIDs identifying the media content, and thus media files, associated with the previews selected for purchase. In addition, the purchase selections may include information defining a desired format such as, for example, MP3 or Advanced Audio Coding (AAC) for songs or MPEG or Audio Video Interleave (AVI) for videos. The desired format may alternatively be stored in the user profile of the user associated with the portable media player 12 and the user system 14.

In response, the user system 14 interacts with the central system 16 to purchase the selections (step 120). The selections may be purchased using an automated process wherein the purchase selections are provided to the central system 16, the central system 16 returns a price for purchasing the selections, and the user agrees to the purchase. The purchased media files corresponding to the purchased media content are then downloaded to the user system 14 (step 122). Thereafter, when the portable media player 12 is docked at the user system 14, the purchased media files are provided to the portable media player 12 (step 124).

Alternatively, if the previews are the entire media files with DRM restrictions, keys for unlocking the purchased media files, rather than the media files, may be downloaded to the user system 14. The keys may then be provided to the portable media player 12 and used to unlock the purchased media files. As another alternative, the portions of the purchased media files other than previews may be provided to the user system 14. The portions of the purchased media files may then be combined with the corresponding previews at either the user system 14 or the portable media player 12 to provide the purchased media files.

Although not illustrated for clarity, the play history for the portable media player 12, or updates thereto, may be provided to the user system 14 each time the portable media player 12 is docked, where the play history may be used to obtain new previews that may subsequently be provided to the portable media player 12.

FIGS. 2B-2D are substantially the same as FIG. 2A and illustrate exemplary variations in when the portable media player 12 is docked to the user system 14. In FIG. 2B, the portable media player 12 is docked to the user system 14 while steps 106-114 are performed. As a result, the previews provided to the portable media player 12 in step 114 are selected based on the current play history of the portable media player 12. Note that in FIG. 2A, since media files may have been played while the portable media player 12 was undocked, the play history of the portable media player 12 may have changed between the time that the play history is provided to the user system 14 in step 106 and the time that the previews are provided to the portable media player 12 in step 112. Thus, the previews provided to the portable media player 12 were selected based on a previous play history rather than a current play history of the portable media player 12. The process of FIG. 2A may be desirable when a quick transfer of previously obtained previews is desired. The process of FIG. 2B may be desirable when the portable media player 12 is to be docked for a substantial amount of time, such as when the battery is being recharged, in order to obtain previews based on the current play history of the portable media player 12.

FIG. 2C illustrates a third embodiment. Again, the process is substantially the same as described above with respect to FIG. 2B. However, in this embodiment, the portable media player 12 remains docked while steps 118-124 are performed to purchase the selected media files.

FIG. 2D illustrates a fourth embodiment. The process is substantially the same as described above with respect to FIG. 2A. However, in this embodiment, the portable media player 12 remains docked while steps 118-124 are performed to purchase the selected media files.

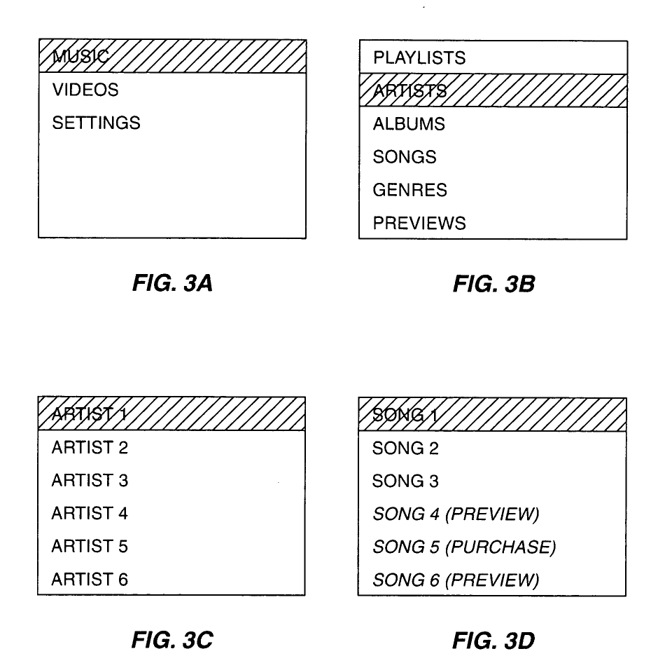

FIGS. 3A-3D illustrate an exemplary graphical user interface for the portable media player 12 enabling the user to play previews provided to the portable media player 12 according to the present invention. As illustrated in FIG. 3A, the user may first select whether he or she desires to play music, play videos, or adjust the settings of the portable media player 12. In this example, the user has selected MUSIC. Thus, as illustrated in FIG. 3B, the user may then select whether he or she desires to view a list of play lists, artists, albums, songs, genres, or previews. If the user selects play lists, a number of play lists generated by the user may then be presented to the user. Previews may be randomly, periodically, or otherwise inserted into the play lists. If the user selects artists, a list of artists for which songs or previews are stored on the portable media player 12 may then be presented to the user. In a similar fashion, lists of albums, songs, genres, and previews may be presented to the user if selected.

In this example, the user selects ARTISTS. As a result, a list of artists is presented to the user, as illustrated in FIG. 3C. The list of artists includes artists for which songs are stored on the portable media player 12. The user may then select an artist to view a list of songs and previews stored on the portable media player 12 for the selected artist. In this example, the user has selected ARTIST 1. As a result, a list of songs and previews for the selected artist are presented to the user, as illustrated in FIG. 3D. In this example, there are three previews for the selected artist, where the previews are identified by being displayed in italics. The previews may alternatively be identified using a different font, different color, some other indicator, or any combination thereof. In addition, the previews that have not yet been played or that have been played but not purchased may be identified by placing “preview” beside the song title. Previews selected by the user for purchase may be identified by placing “purchase” beside the song title.

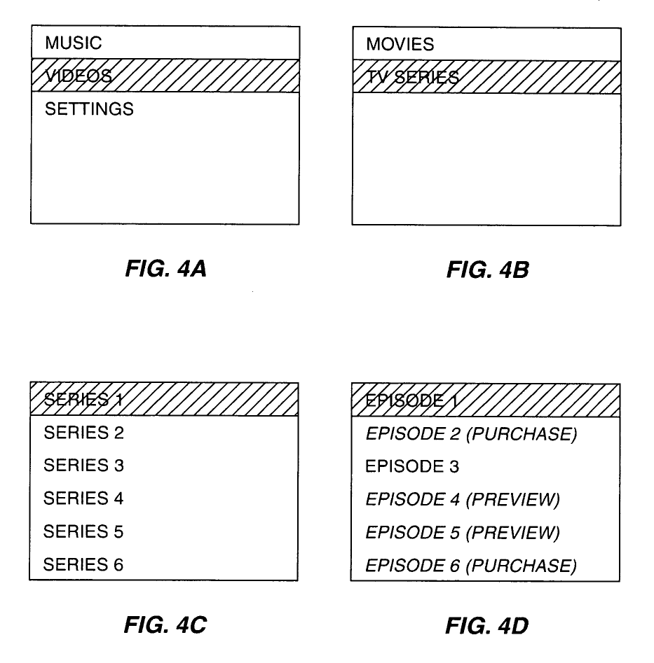

FIGS. 4A-4D are similar to FIGS. 3A-3D. However, FIGS. 4A-4D illustrate the situation where a user desires to play videos rather than music. As illustrated, the user may navigate through the graphical user interface until a list of videos is presented. As illustrated in FIG. 4D, the list of videos includes both owned videos and previews. The previews may be may be identified using a different font, different color, some other indicator, or any combination thereof. In this example, the previews are identified by being displayed in italics. In addition, previews that have not yet been played or that have been played but not purchased may be identified by placing “preview” beside the video title. Previews selected by the user for purchase may be identified by placing “purchase” beside the video title.

In addition to the visual indicators used in the exemplary graphical user interface of FIGS. 3A-3D and 4A-4D, previews and the status of the previews may be additionally or alternatively indicated using audible tones or messages. For example, a single audible tone may be played before a preview begins playback for the first time, two audible tones may be played before a preview that has been previously played but not selected for purchase begins playback, and three audible tones may be played before a preview that has been selected for purchase. In a similar fashion, prerecorded audio messages, such as “new,” “unpurchased,” or “purchased,” may be played before playback of a preview to provide the status of the preview.

Further, a preview may be selected for purchase in a number of manners. In one embodiment, while the preview is being played, the user may be presented with a graphical user interface including a “purchase” button, wherein the user may select the “purchase” button using a physical user interface of the portable media player 12. In addition or as an alternative, the user may select previews for purchase via the user interface of the portable media player 12 while the previews are not playing.

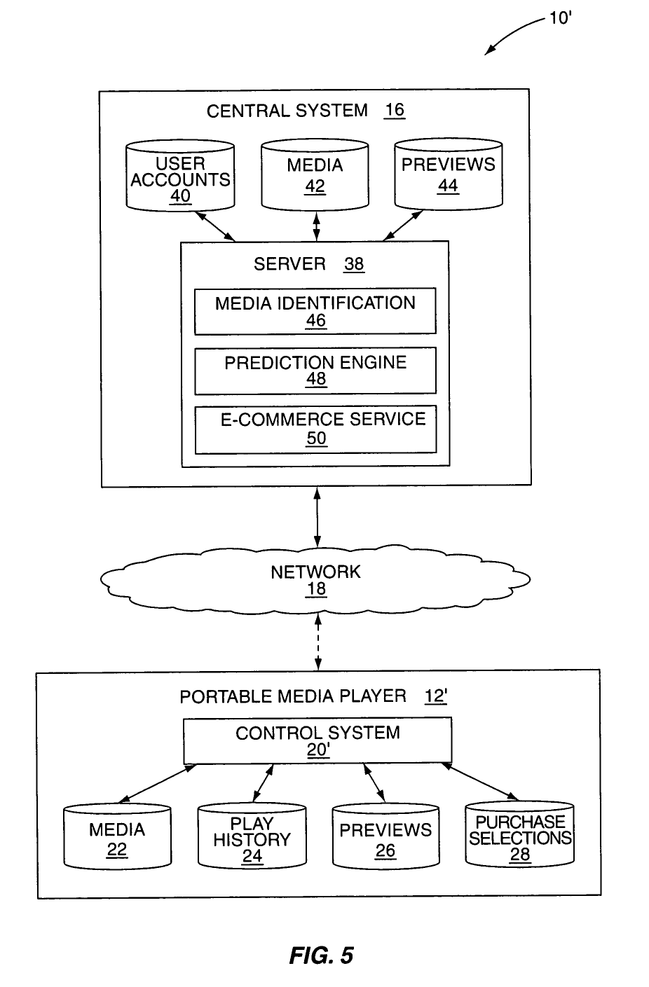

FIG. 5 illustrates a system 10′ operating to provide previews to a portable media player 12′ according to a second embodiment of the present invention. This embodiment is substantially the same as that discussed above. However, the portable media player 12′ includes a wireless communication interface, such as a wireless interface to a cellular network or the like, and operates to directly communicate with the central system 16 via the network 18 to obtain previews and, optionally, purchase media files corresponding to select ones of the previews.

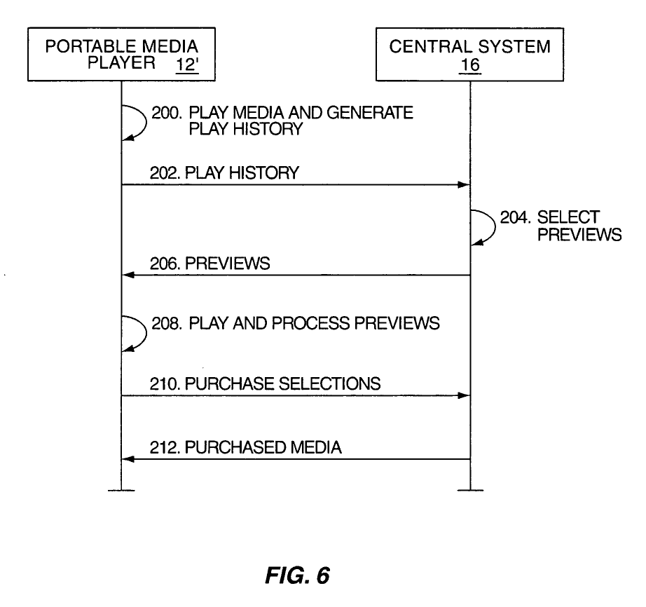

FIG. 6 illustrates the operation of the system 10′ according to one embodiment of the present invention. First, media files are played by the portable media player 12′ and a play history is generated (step 200). Note that the media files stored on the portable media player 12′ may be provided from an associated user system, such as the user system 14 (FIG. 1), during a synchronization process. In addition, the media files may have been purchased and downloaded from the central system 16.

The play history is then provided to the central system 16 (step 202). The play history may be periodically sent to the central system 16, updates to the play history may be sent to the central system 16 as media files are played, or the play history may be sent to the central system 16 upon receiving a user request for previews. In addition, if wireless connectivity to the network 18 is interrupted, the play history may be provided to the central system 16 when connectivity is reestablished. Further, although not illustrated, a play history from an associated user system, such as the user system 14 (FIG. 1), may also be provided to the central system 16 and associated with the play history from the portable media player 12′.

Based on the play history from the portable media player 12′ and, optionally, the play history from the user system 14 and the user profile of the associated user, the central system 16, and specifically the prediction engine 48, selects previews for the portable media player 12′ (step 204). The prediction engine 48 may additionally select the previews based on the information identifying the music collection 32 of the user. As discussed above, the information identifying the media content of the media files in the media collection 32 may be stored at the central system 16 as part of the user profile of the associated user. As discussed above, the selected previews may be obtained from the previews database 44 or dynamically generated from the media database 42. The selected previews are then provided to the portable media player 12′ (step 206). The previews may be played and processed on the portable media player 12′ (step 208). More specifically, the previews may be played by the portable media player 12′. Upon viewing or listening to each of the previews, the user may select the preview for purchase, mark the preview for removal or deletion, mark the preview as “hold,” or mark the preview as “watch for promotion.”

Once previews are selected for purchase, the portable media player 12′ communicates with the central system 16 to purchase the selections (step 210). The selections may be sent individually as previews are selected for purchase, periodically in a batch process, or as requested by the user. Preferably, the purchase selections are the GUIDs identifying the media content, and thus the media files, associated with the previews selected for purchase. The selections may be purchased using an automated process wherein the purchase selections are provided to the central system 16, the central system 16 returns a price for purchasing the selections, and the user agrees to the purchase. The purchased media files are then downloaded to the portable media player 12′ (step 212). Alternatively, if the previews are the entire media files with DRM restrictions, keys for unlocking the purchased media files, rather than the media files, may be downloaded to the portable media player 12′ and used to unlock the purchased media files. As another alternative, the portions of the purchased media files other than previews may be provided to the user system 14, wherein the portions of the purchased media files are combined with the corresponding previews at the portable media player 12′ to provide the purchased media files.

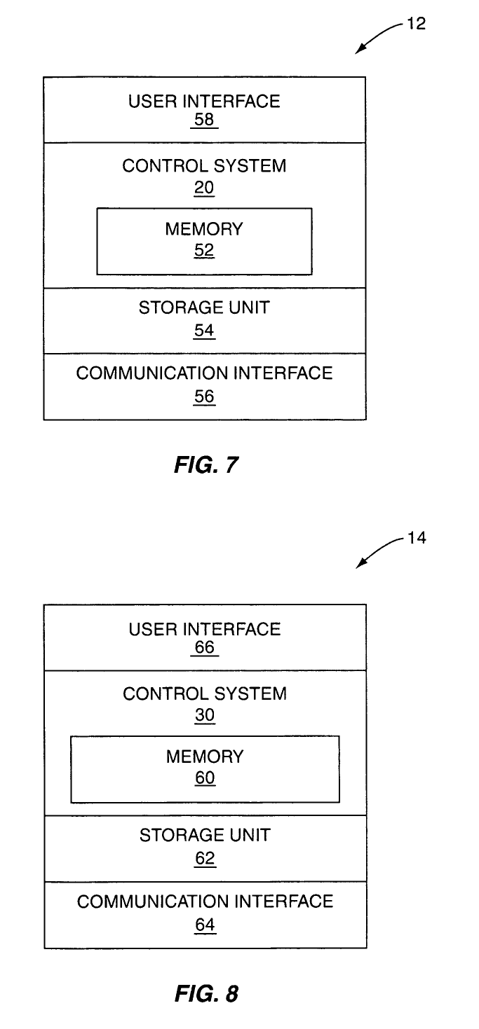

FIG. 7 is a block diagram of an exemplary embodiment of the portable media player 12 of FIG. 1. In general, the portable media player 12 includes the control system 20 having associated memory 52. The memory 52 operates to store software instructing the portable media player 12 to operate according to the present invention. The portable media player 12 also includes a storage unit 54, which may be, for example, a hard-disc drive or the like. The databases 22-28 (FIG. 1) may be implemented in the storage unit 54. Alternatively, the databases 22-28, or a portion thereof, may be implemented in the memory 52. The portable media player 12 also includes a communication interface 56. The communication interface 56 enables communication with the user system 14 (FIG. 1) and may be a wireless or wired interface. In addition, the portable media player 12 includes a user interface 58, which may include a display, speakers, input buttons or dials, or the like.

FIG. 8 is a block diagram of an exemplary embodiment of the user system 14 of FIG. 1. In general, the user system 14 includes the control system 30 having associated memory 60. The memory 60 operates to store software instructing the user system 14 to operate according to the present invention. The user system 14 also includes a storage unit 62, which may be, for example, a hard-disc drive or the like. The databases 32-36 (FIG. 1) may be implemented in the storage unit 62. Alternatively, the databases 32-36, or a portion thereof, may be implemented in the memory 60. The user system 14 also includes a communication interface 64. The communication interface 64 may include a first interface communicatively coupling the user system 14 to the network 18 (FIG. 1) and a second interface providing either wireless or wired communication with the portable media player 12 (FIG. 1) during a docking, or synchronization, process. In addition, the user system 14 includes a user interface 66, which may include a display, speakers, one or more input devices, or the like.

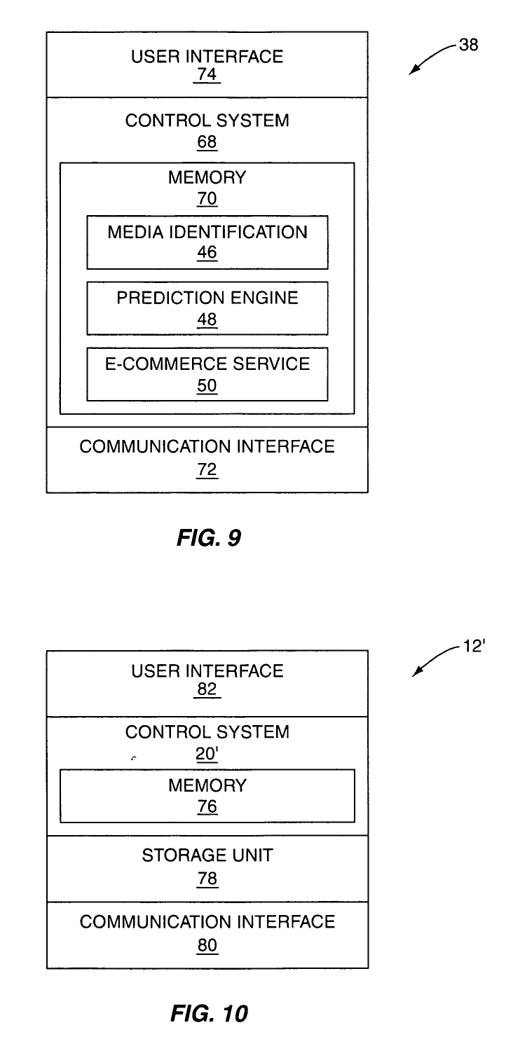

FIG. 9 is a block diagram of an exemplary embodiment of the server 38 of FIG. 1. In general, the server 38 includes a control system 68 having associated memory 70. The memory 70 operates to store software instructing the server 38 to operate according to the present invention. In this example, the media identification application 46, the prediction engine 48, and the e-commerce service 50 are implemented, at least partially, in software and are stored in the memory 70. The databases 40-44 (FIG. 1) may be implemented in a storage unit associated with the server 38. Alternatively, the databases 40-44, or a portion thereof, may be implemented in the memory 70. The server 38 also includes a communication interface 72. The communication interface 72 communicatively couples the server 38 to the network 18 (FIG. 1). In addition, the server 38 includes a user interface 74, which may include a display, speakers, one or more input devices, or the like.

FIG. 10 is a block diagram of an exemplary embodiment of the portable media player 12′ of FIG. 5. In general, the portable media player 12′ includes the control system 20′ having associated memory 76. The memory 76 operates to store software instructing the portable media player 12′ to operate according to the present invention. The portable media player 12′ also includes a storage unit 78, which may be, for example, a hard-disc drive or the like. The databases 22-28 (FIG. 5) may be implemented in the storage unit 78. Alternatively, the databases 22-28, or a portion thereof, may be implemented in the memory 76. The portable media player 12′ also includes a communication interface 80. The communication interface 80 is a wireless communication interface communicatively coupling the portable media player 12′ to the network 18 (FIG. 5). In addition, the portable media player 12′ includes a user interface 82, which may include a display, speakers, input buttons or dials, or the like.

Those skilled in the art will recognize improvements and modifications to the preferred embodiments of the present invention. All such improvements and modifications are considered within the scope of the concepts disclosed herein and the claims that follow.

What is claimed is:

1. A method comprising:
receiving a play history of a portable media player from a user system associated with the portable media player;
selecting a plurality of previews for the portable media player based on the play history; and
providing the plurality of previews to the user system, wherein the user system provides the plurality of previews to the portable media player.

2. The method of claim 1 wherein the user system receives the play history from the portable media player during a docking process and provides the plurality of previews to the portable media player during the docking process or during a subsequent docking process.

3. The method of claim 1 further comprising:
receiving information identifying one of the plurality of previews selected for purchase at the portable media player from the user system; and
providing a media file corresponding to the one of the plurality of previews to the user system, wherein the user system provides the media file to the portable media player.

4. The method of claim 3 wherein the user system receives the information identifying the one of the plurality of previews from the portable media player during a first subsequent docking process and provides the media file to the portable media player during the first subsequent docking process or a second subsequent docking process.

5. The method of claim 3 wherein providing the media file further comprises providing the media file in a desired format selected by a user associated with the portable media player.

6. The method of claim 1 wherein the portable media player stores a plurality of media files, and the play history comprises information identifying media content of ones of the plurality of media files played by the portable media player and time stamps defining times at which the ones of the plurality of media files were played by the portable media player.

7. The method of claim 1 further comprising:
communicating with the user system to identify media content of a plurality of media files forming a user media collection stored at the user system; and
storing information identifying the media content of the plurality of media files in the user media collection;
wherein selecting the plurality of previews for the portable media player comprises selecting the plurality of previews for the portable media player based on the play history and the information identifying the media content of the plurality of media files in the user media collection.

8. The method of claim 1 further comprising receiving a play history of the user system from the user system associated with the portable media player;
wherein selecting the plurality of previews for the portable media player comprises selecting the plurality of previews for the portable media player based on the play history of the portable media player and the play history of the user system.

9. The method of claim 1 wherein each one of the plurality of previews is a media file comprising complete media content associated with the one of the plurality of previews and Digital Rights Management (DRM) restrictions limiting playback of the complete media content to provide the one of the plurality of previews.

10. The method of claim 9 further comprising:
receiving information identifying one of the plurality of previews selected for purchase at the portable media player from the user system; and
providing information enabling playback of the complete media content of the media file corresponding to the one of the plurality of previews selected for purchase to user system, wherein the user system provides the information enabling playback of the complete media content of the media file to the portable media player.

11. The method of claim 10 wherein the user system receives the information identifying the one of the plurality of previews from the portable media player during a first subsequent docking process and provides the information enabling playback of the complete media content of the media file to the portable media player during the first subsequent docking process or a second subsequent docking process.

12. The method of claim 1 wherein the plurality of previews are segments of a corresponding plurality of media files, and the method further comprises:
receiving information identifying one of the plurality of previews selected for purchase at the portable media player from the user system; and
providing a non-previewed portion of a one of the plurality of media files corresponding to the one of the plurality of previews to the user system, wherein the non-previewed portion of the one of the plurality of media files and the one of the plurality of previews are combined to provide the one of the plurality of media files corresponding the one of the plurality of previews.

13. A central system comprising:
a communication interface communicatively coupling the central system to a user system associated with a portable media player; and
a control system adapted to:
receive a play history of the portable media player from the user system;
select a plurality of previews for the portable media player based on the play history; and
provide the plurality of previews to the user system, wherein the user system provides the plurality of previews to the portable media player.

14. A method comprising:
receiving a play history of a portable media player from the portable media player via a network;
selecting a plurality of previews for the portable media player based on the play history; and
providing the plurality of previews to the portable media player via the network.

15. The method of claim 14 further comprising:
receiving information identifying one of the plurality of previews selected for purchase at the portable media player from the portable media player; and
providing a media file corresponding to the one of the plurality of previews to the portable media player.

16. The method of claim 15 wherein providing the media file further comprises providing the media file in a desired format selected by a user associated with the portable media player.

17. The method of claim 14 wherein the portable media player stores a plurality of media files, and the play history comprises information identifying media content of ones of the plurality of media files played by the portable media player and time stamps defining times at which the ones of the plurality of media files were played by the portable media player.

18. The method of claim 14 wherein each one of the plurality of previews is a media file comprising complete media content associated with the one of the plurality of previews and Digital Rights Management (DRM) restrictions limiting playback of the complete media content to provide the one of the plurality of previews.

19. The method of claim 18 further comprising:
receiving information identifying one of the plurality of previews selected for purchase at the portable media player from the portable media player; and
providing information enabling playback of the complete media content of the media file corresponding to the one of the plurality of previews selected for purchase to the portable media player.

20. The method of claim 14 wherein the plurality of previews are segments of a corresponding plurality of media files, and the method further comprises:
receiving information identifying one of the plurality of previews selected for purchase at the portable media player from the portable media player; and
providing a non-previewed portion of a one of the plurality of media files corresponding to the one of the plurality of previews to the portable media player, wherein the non-previewed portion of the one of the plurality of media files and the one of the plurality of previews are combined to provide the one of the plurality of media files corresponding the one of the plurality of previews.

21. A central system comprising:
a communication interface communicatively coupling the central system to a portable media player via a network; and
a control system adapted to:
receive a play history of the portable media player from the portable media player;
select a plurality of previews for the portable media player based on the play history; and
provide the plurality of previews to the portable media player.
